(19) United States
(12) Patent Application Publication
(10) Pub. No.: US 2017/0366563 A1
(43) Pub. Date: Dec. 21, 2017

(54) Agentless ransomware detection and recovery

(71) Applicant: Guardicore Ltd., Tel Aviv (IL)

(72) Inventors: Michael Volfman, Tel-Aviv (IL); Pavel Gurvich, Tel-Aviv (IL); Ariel Zeitlin, Kfar Saba (IL)

(21) Appl. No.: 15/623,401

(22) Filed: Jun. 15, 2017

Related U.S. Application Data
(60) Provisional application No. 62/352,582, filed on Jun. 21, 2016.

(51) Int. Cl. H04L 29/06

(52) U.S. Cl. CPC H04L 63/1416; H04L 63/1491

(57) ABSTRACT

A network security apparatus includes an interface and a processor. The interface is configured to communicate at least with an endpoint computer over a network. The processor is configured to create a trap resource that is shared between the network security apparatus and an operating system of the endpoint computer, to detect ransomware activity in the shared resource, and to initiate a responsive action in response to the detected ransomware activity.

### CROSS-REFERENCE TO RELATED APPLICATIONS

This application claims the benefit of U.S. Provisional Patent Application 62/352,582, filed Jun. 21, 2016, whose disclosure is incorporated herein by reference.

### FIELD OF THE INVENTION

The present invention relates generally to computer network security, and particularly to methods and systems for protection against ransomware.

### BACKGROUND OF THE INVENTION

“Ransomware” is a term used to describe various types of malicious software, which take control over a computer or information stored therein and render it inaccessible to the user until a ransom is paid. Ransomware may, for example, encrypt files on the user's computer, and decrypt them only in return for ransom.

### SUMMARY OF THE INVENTION

An embodiment of the present invention that is described herein provides a network security apparatus including an interface and a processor. The interface is configured to communicate at least with an endpoint computer over a network. The processor is configured to create a trap resource that is shared between the network security apparatus and an operating system of the endpoint computer, to detect ransomware activity in the shared resource, and to initiate a responsive action in response to the detected ransomware activity.

In some embodiments, the processor is configured to create the trap resource in the server and to share the trap resource with the operating system of the endpoint computer. In other embodiments, the processor is configured to create the trap resource in the operating system of the endpoint computer and to share the trap resource with the server. Typically, the processor is configured to detect the ransomware activity without adding any agent to the endpoint computer.

In an embodiment, the shared resource includes a directory that is shared between the network security apparatus and the operating system of the endpoint computer. Additionally or alternatively, the shared resource may include a file that is shared between the network security apparatus and the operating system of the endpoint computer.

In a disclosed embodiment, the processor is configured to create the trap resource by running a command-line in the endpoint computer. In another embodiment, the processor is configured to create the trap resource in the network security apparatus on-the-fly, in response to an access attempt by the endpoint computer. In yet another embodiment, the processor is configured to assign first and second clones of the trap resource, having identical names but addressed by different IP addresses, to the endpoint computer and to another endpoint computer.

There is additionally provided, in accordance with an embodiment of the present invention, a method for network security including creating a trap resource that is shared between a network security system and an operating system of an endpoint computer. Ransomware activity is detected in the shared resource using the network security system. A responsive action is initiated in response to the detected ransomware activity.

There is further provided, in accordance with an embodiment of the present invention, a computer software product, the product including a tangible non-transitory computer-readable medium in which program instructions are stored, which instructions, when read by a processor of a network security system, cause the processor to communicate at least with an endpoint computer over a network, to create a trap resource that is shared between the network security system and an operating system of the endpoint computer, to detect ransomware activity in the shared resource, and to initiate a responsive action in response to the detected ransomware activity.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computer system that employs protection against ransomware, in accordance with an embodiment of the present invention; and

FIG. 2 is a flow chart that schematically illustrates a method for agentless ransomware protection, in accordance with an embodiment of the present invention.

### DETAILED DESCRIPTION OF EMBODIMENTS

### Overview

Embodiments of the present invention that are described herein provide improved methods and systems for protecting endpoint computers connected to a network against ransomware attacks. In particular, the disclosed techniques are agentless, i.e., do not require adding, installation or execution of any sort of agents or other software to the endpoint computers. As such, the disclosed solution is highly scalable and easy to manage.

In some embodiments, a ransomware mitigation server (referred to as “server” for brevity) monitors the endpoint computers (referred to as “endpoints” for brevity) and protects them against ransomware. To protect a given endpoint, the server creates at least one “trap” resource, e.g., a trap directory or file. The trap directory or file is shared between the server and the endpoint's operating system, thereby enabling the server to monitor activity occurring therein. As will be demonstrated below, the trap resource may be created in the server and shared with the endpoint operating system, or vice versa.

The trap directory or file is typically designed in a manner that is likely to cause ransomware to attack it. In response to detecting suspected ransomware activity in a trap directory or file, the server initiates suitable protective and/or corrective action.

Unlike other possible solutions, in which the attack is diverted or redirected to a security server, e.g., a honeypot, in the disclosed techniques the ransomware genuinely attacks a directory or file that is associated with (although not always physically resides in) the operating system of the intended target endpoint. By using the sharing mechanism of the server and the endpoint operating system, the server is able to create and monitor a resource that is (i) associated with the endpoint operating system and (ii) dedicated for ransomware detection, but without having to add any sort of agent or persistent software of any kind to the endpoint.

### System Description

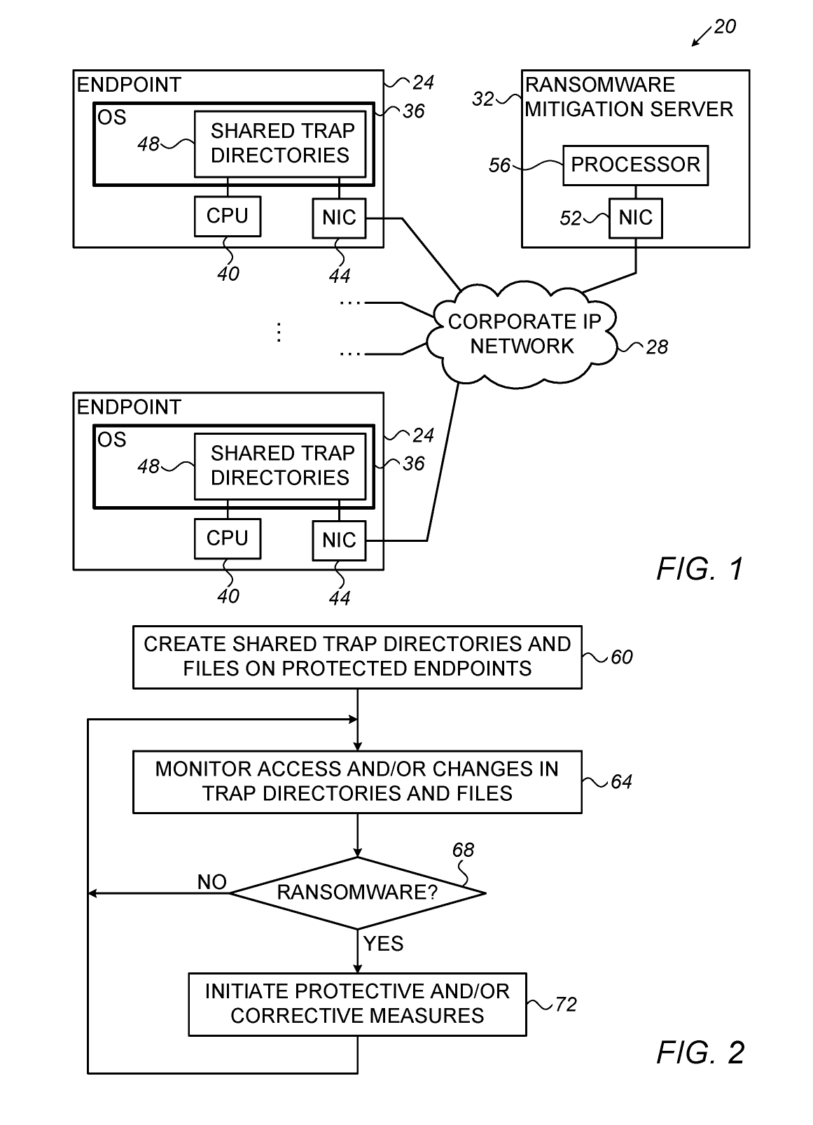

FIG. 1 is a block diagram that schematically illustrates a computer system 20 that employs protection against ransomware, in accordance with an embodiment of the present invention. In the present example system 20 comprises multiple endpoint computers (“endpoints”) 24, which communicate with one another and access the Internet via a corporate Internet Protocol (IP) network 28. A ransomware mitigation server (“server”) 32 detects and mitigates ransomware attacks on endpoints 24 using methods that are described in detail herein. In alternative embodiments, the disclosed techniques can be used to protect any other suitable endpoints in any other suitable system, e.g., servers in a data center.

Each endpoint 24 may comprise any suitable type of physical computer, e.g., a workstation or a personal or mobile computer. In some embodiments, physical endpoints may be used for hosting Virtual Machines (VMs), as will be addressed below. Network 28 may comprise, for example, a Wide-Area Network (WAN) such as the Internet, a Local Area Network (LAN) or any other suitable network or combination of networks. Network 28 and/or its components may be wired and/or wireless. Network 28 is typically also connected to the Internet, e.g., via some Internet Service Provider (ISP) access network.

Each endpoint 24 in system 20 typically comprises a network interface, e.g., a Network Interface Controller (NIC) 44, for communicating over network 28. Each endpoint further comprises a processor, e.g., a Central Processing Unit (CPU) 40 that is configured to carry out the various processing tasks of the endpoint. Each endpoint typically comprises additional elements such as memory, e.g., one or more Random Access Memory (RAM) devices, and storage, e.g., one or more disks (not shown in the figure for clarity).

In each endpoint 24, CPU 40 runs an Operating System (OS) 36, such as Microsoft Windows, Linux or any other suitable type of OS. OS 36 typically comprises a file system that defines a structure of directories and files. OS 36 comprises suitable provisions (e.g., commands, protocols and/or data structures) for sharing files and directories with other computers over network 28.

In some embodiments, ransomware mitigation server 32 comprises a network interface, e.g., a NIC 52, for communicating over network 28, and a processor 56 that is configured to carry out the various tasks of server 32. Among other tasks, processor 56 creates shared “trap” resources, e.g., shared directories and/or files 48.

For a given endpoint 24, trap directories and/or files 48 are shared between processor 52 of server 32 and OS 36 of the endpoint. The trap directories and/or files are shown in the figure as part of OS 36 for the sake of clarity, although in some embodiments they reside physically on server 32.

For example, in some embodiments processor 56 creates the trap directories and/or files in server 32, and shares them with endpoint 24. In these embodiments, the actual content of the trap directories and/or files resides on server 32. Endpoint 24 is configured to map or link the shared trap directories and/or files in its file system, e.g., using Linux “mount” command or Windows “mklink” command for NTFS. When ransomware attacks such a file or directory, the ransomware activity is physically performed on server 32, and processor 56 is thus able to detect and track it.

In alternative embodiments, processor 56 creates trap directories and/or files 48 in OSs 36 of endpoints 24. In these embodiments, the actual content of the trap directories and/or files resides in endpoint 24, and the trap directories and/or files are shared with processor 56 of server 32. When ransomware attacks such a file or directory, the ransomware activity is physically performed on endpoint 24, and processor 56 is able to detect and track it remotely due to the sharing.

In an example embodiment, the trap directories comprise remote Server Message Block (SMB) shares, and processor 56 runs an SMB service that hosts these remote shares on endpoints 24. Processor 56 uses the trap directories and/or files for detecting ransomware activity. Server 32 is also referred to herein as a network security apparatus or system. The functions of server 32 may be carried out by any suitable computing platform.

The configuration shown in FIG. 1 of system 20 and its components, e.g., endpoints 24 and server 32, is an example configuration that is depicted purely for the sake of conceptual clarity. In alternative embodiments, any other suitable system and system-component configuration can be used. The different elements shown in FIG. 1 may be implemented using any suitable hardware, such as in an Application-Specific Integrated Circuit (ASIC) or Field-Programmable Gate Array (FPGA). Alternatively, suitable system components can be implemented using software, or using a combination of hardware and software elements.

Typically, CPU 40 of server endpoints 24 and processor 56 of server 32 comprise programmable processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Shared Trap Resources for Ransomware Protection

In some embodiments, processor 56 of server 32 detects suspected ransomware activity in endpoints 24 by monitoring the activity in trap directories and/or files 48. The embodiments described herein refer mainly to files and directories, but the disclosed techniques can be implemented using other suitable resources that (i) can be attacked by ransomware and (ii) can be shared between endpoint 24 and server 32.

In an embodiment, processor 56 may create a shared trap directory by adding a new mapped drive (which is shared with processor 56) on an endpoint 24. In another embodiment, processor 56 may create a shared trap directory by adding a new (shared) directory in an existing share.

In an example embodiment, a trap resource comprises a shared directory that is created for the sole purpose of detecting ransomware. In this embodiment, the user of endpoint 24, or legitimate software running in endpoint 24, has no need or reason to access the trap directory. As such, any access to the trap directory can be regarded as suspicious. Processor 56 may create and store in the trap directory one or more “trap files,” i.e., one or more shared files dedicated for ransomware detection. In another embodiment the trap directory may be left empty.

In yet another embodiment, the trap resource comprises shared trap files that processor 56 stores in an existing, functional directory (of OS 36 or of server 32). In this embodiment, access to the directory in question is not necessarily suspicious, but access to the trap files is.

When using trap files (whether in a trap directory or in a functional directory), processor 56 may create and store one or more files whose type, filename, size, content or other characteristics are known to have a high likelihood of being attacked by ransomware. Such file types may comprise, for example, Microsoft Office documents or spreadsheets, image or video files, or any other suitable file types that are known or expected to attract ransomware.

In alternative embodiments, processor 56 may use any other suitable technique for sharing a file or directory between endpoint 24 and server 32. Several non-limiting examples may include sharing and mounting remote files in the file system of OS 36, e.g., using conventional operating-system backup and synchronization services (e.g., Linux Rsync), or using third-party applications (e.g., Dropbox or Microsoft OneDrive desktop applications).

### Agentless Ransomware Protection Using Shared Trap Resources

As noted above, endpoints 24 are exposed to ransomware attacks, e.g., by attackers external to system 20 that access endpoints 24 via their connection to the Internet. A typical, although not exclusive, modus operandi of a ransomware attack is to encrypt certain files stored on the endpoint and delete the original files. The ransomware would then demand that the user pay ransom in order to regain access to his files.

FIG. 2 is a flow chart that schematically illustrates a method for agentless ransomware protection, in accordance with an embodiment of the present invention. The method begins with processor 56 of server 32 creating shared trap directories and/or files 48, at a trap creation step 60.

In various embodiments, processor 56 may create shared trap directories and/or files 48 in various ways. In a virtualized computing system, for example, processor 56 may use existing Virtual Machine (VM) management tools to run a command-line inside a VM on an endpoint 24. As another example, processor 56 may use an external deployment mechanism, e.g., a group policy in Windows domain environments. As yet another example, processor 56 may use a deployment management tool such as Chef, Puppet or Ansible. Further alternatively, processor 56 may create shared trap directories and/or files 48 by accessing endpoints 24 using administrator credentials. In any of these techniques, processor 56 may run in an endpoint 24 a command line that creates the desired shared trap directories and/or files 48. Additionally or alternatively, processor 56 may create shared trap directories and/or files 48 in any other suitable way.

At a monitoring step 64, processor 56 monitors activity occurring in the shared trap directories and/or files 48. Typically although not necessarily, processor focuses on monitoring write activity. Monitored activity may comprise, for example, access to a trap directory in general, creation of a new file in a trap directory, modification of a trap file or of an existing file in general in a trap directory, deletion of a trap file, a request to list the items in a trap folder, or any other suitable type of activity. In some embodiments processor 56 logs some or all of the monitored activity for later analysis.

At a ransomware checking step 68, processor 56 checks whether the monitored activity is likely to be indicative of ransomware or not. Processor 56 may use various criteria for this purpose. For example, processor 56 may check whether a certain file is encrypted or not.

One example criterion for checking whether a file is encrypted is the entropy of the content of the file (also referred to as “Information entropy” or “Shannon entropy”). The entropy of a file may be defined as

$${\sum }_{i = 0}^{N - 1} - \frac{{count}_{i}}{N} \cdot {log}_{2} ( \frac{{count}_{i}}{N} ) ,$$

wherein N denotes the length of the file in bytes, n=256 (the number of possible values of a byte), and countᵢ denotes the number of times the byte value i appears in the file. The expression above is typically divided by log₂ n=8, so as to normalize the entropy to a value between zero and unity.

Typically, an encrypted file has an entropy approaching unity. Thus, processor 56 may compare the file entropy to a predefined threshold, e.g., 0.9 or other suitable value. If the file entropy is above the threshold, processor 56 may conclude that the file is likely encrypted. If the file entropy is below the threshold, processor 56 may conclude that the file is likely non-encrypted.

In some embodiments, before declaring a high-entropy file as likely to be encrypted, processor 56 may first verify that the file does not conform to a known compressed-file format. Since compressed files are also typically characterized by high entropy, this additional verification may be necessary for avoiding false detections.

In some embodiments, processor 56 may check whether a new encrypted file has been added to a trap directory, or whether a non-encrypted trap file has been encrypted. More generally, processor 56 may check whether a trap file that was previously accessible to the user is now inaccessible. Additionally or alternatively, processor 56 may use any other suitable method or criterion for checking whether the monitored activity in shared trap directories and/or files 48 is indicative of ransomware or not.

If no ransomware activity is detected at step 68, the method loops back to step 64 above, in which processor 56 continues to monitor the activity in trap directories and/or files 48 of endpoints 24.

If a certain monitored activity in a shared trap directory or file 48 of a certain endpoint 24 appears indicative of ransomware activity, processor 56 initiates a suitable responsive action, at a responding step 72. Any suitable responsive action may be taken. Some example responsive actions aim to stop or contain the attack. Other example responsive actions aim to remedy the attack and restore attacked information. Yet other example responsive actions aim to log characteristics of the attack for later investigation, forensics or evidence.

For example, upon detecting a ransomware attack on a VM running in an endpoint 24, processor 56 may freeze the VM, acquire a memory snapshot of the VM, disconnect one or more of the VMs virtual network interfaces (VNICs), and/or migrate the VM to an alternative location such as a quarantine network, e.g., by connecting to VM to a different port group.

As another example, processor 56 may use administrator credentials to connect to an attacked endpoint 24 (or to an attacked VM running in an endpoint 24). Processor 56 may then acquire a memory dump for later forensic analysis, identify and terminate the malicious process (or a user/system process that hosts the malicious activity), shut-down the VM or endpoint, and/or identify and disable the users logged-in to the attacked VM or endpoint.

Other example responsive actions involve access of processor 56 to system elements external to the attacked endpoint. For example, processor 56 may connect to a network switch (e.g., in network 28) and disable the switch port that serves the attacked endpoint. As another example, when the attacked endpoint is served by an Access Point (AP) of a Wireless LAN (WLAN), processor 56 may connect to the AP and disable the Medium Access Control (MAC) address of the attacked endpoint. As yet another example, processor 56 may configure a network firewall (e.g., in network 28) to drop traffic associated with the attacked endpoint's IP or MAC addresses. As another example, processor 56 may use a Network Access Control (NAC) solution to disconnect the attacked endpoint or migrate it to a quarantine network or Virtual LAN (VLAN).

Additionally or alternatively, processor 56 may take responsive actions that attempt to restore some or all of the information that was encrypted by the ransomware. For example, a memory snapshot of an attacked endpoint that was acquired during the attack may contain an encryption key used by the ransomware, or data that can be converted into such a key. In some cases it may be possible to recover the encryption key from the memory snapshot, and use the key to decrypt data (e.g., files) that has been encrypted by the ransomware.

The responsive actions listed above are depicted purely by way of example. In alternative embodiments, processor 56 may perform or initiate any other suitable responsive action.

In the embodiments described above, processor 56 creates the trap directories or files in advance. Alternatively, however, processor 56 may create a shared directory or file on-the-fly. In one example embodiment, processor 56 creates in server 32 a share named “share_name”. In addition, multiple endpoints 24 (possibly all endpoints) are configured to map this share to some resource of their OS 32. Upon detecting a request (e.g., SMB access request) to access a new combination of {IP address, “share_name”} (meaning that an endpoint that never accessed this share now requests to access it for the first time), processor 56 creates on-the-fly, on server 32, a new copy of the share that is shared with the endpoint in question. Processor 56 then diverts subsequent requests (e.g., from the same IP and share name) to their corresponding shares on the server.

In the above embodiment, a single physical share on server 32 serves as a trap resource for multiple {IP address, share name} combinations arriving from different endpoints. Processor 56 diverts accesses from the various endpoints to the appropriate clones of this share. Thus, the server exposes different shares to each endpoints, all having the same name, and is able to monitor ransomware activity for each share independently of the others.

The above technique (generating shared trap resources on-the-fly, and using different clones of the share name to serve different respective endpoints) eliminates the need to create on the server trap resources in advance per endpoint. This solution is useful, for example, when the endpoints comprise VMs that may be generated on-the-fly. When using this solution, several different shared resource names may be accessed by the same endpoint IP. Each shared resource name will typically be assigned its own unique resource in server 32, even if they are identical to resource names used by other endpoint IP addresses.

Although the embodiments described herein mainly address ransomware detection, the methods and systems described herein can also be used in other applications, such as in detecting other types of malware using shared trap files or directories.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A network security apparatus, comprising:
an interface, configured to communicate at least with an endpoint computer over a network; and
a processor, which is configured to create a trap resource that is shared between the network security apparatus and an operating system of the endpoint computer, to detect ransomware activity in the shared resource, and to initiate a responsive action in response to the detected ransomware activity.

2. The apparatus according to claim 1, wherein the processor is configured to create the trap resource in the network security apparatus and to share the trap resource with the operating system of the endpoint computer.

3. The apparatus according to claim 1, wherein the processor is configured to create the trap resource in the operating system of the endpoint computer and to share the trap resource with the network security apparatus.

4. The apparatus according to claim 1, wherein the processor is configured to detect the ransomware activity without adding any agent to the endpoint computer.

5. The apparatus according to claim 1, wherein the shared resource comprises a directory that is shared between the network security apparatus and the operating system of the endpoint computer.

6. The apparatus according to claim 1, wherein the shared resource comprises a file that is shared between the network security apparatus and the operating system of the endpoint computer.

7. The apparatus according to claim 1, wherein the processor is configured to create the trap resource by running a command-line in the endpoint computer.

8. The apparatus according to claim 1, wherein the processor is configured to create the trap resource in the network security apparatus on-the-fly, in response to an access attempt by the endpoint computer.

9. The apparatus according to claim 1, wherein the processor is configured to assign first and second clones of the trap resource, having identical names but addressed by different IP addresses, to the endpoint computer and to another endpoint computer.

10. A method for network security, comprising:
creating a trap resource that is shared between a network security system and an operating system of an endpoint computer;
using the network security system, detecting ransomware activity in the shared resource; and
initiating a responsive action in response to the detected ransomware activity.

11. The method according to claim 10, wherein creating the trap resource comprises creating the trap resource in the network security system and sharing the trap resource with the operating system of the endpoint computer.

12. The method according to claim 10, wherein creating the trap resource comprises creating the trap resource in the operating system of the endpoint computer and sharing the trap resource with the network security system.

13. The method according to claim 10, wherein detecting the ransomware activity is performed without adding any agent to the endpoint computer.

14. The method according to claim 10, wherein the shared resource comprises a directory that is shared between the network security system and the operating system of the endpoint computer.

15. The method according to claim 10, wherein the shared resource comprises a file that is shared between the network security system and the operating system of the endpoint computer.

16. The method according to claim 10, wherein creating the trap resource comprises running a command-line in the endpoint computer.

17. The method according to claim 10, wherein creating the trap resource comprises creating the trap resource on-the-fly in the network security system, in response to an access attempt by the endpoint computer.

18. The method according to claim 10, wherein creating the trap resource comprises assigning first and second clones of the trap resource, having identical names but addressed by different IP addresses, to the endpoint computer and to another endpoint computer.

19. A computer software product, the product comprising a tangible non-transitory computer-readable medium in which program instructions are stored, which instructions, when read by a processor of a network security system, cause the processor to communicate at least with an endpoint computer over a network, to create a trap resource that is shared between the network security system and an operating system of the endpoint computer, to detect ransomware activity in the shared resource, and to initiate a responsive action in response to the detected ransomware activity.

20. The product according to claim 19, wherein the instructions cause the processor to detect the ransomware activity without adding any agent to the endpoint computer.
